(19) United States
(12) Patent Application Publication
(10) Pub. No.: US 2024/0153102 A1
(43) Pub. Date: May 9, 2024

(54) METHOD AND DEVICE FOR TRACKING OBJECTS DETECTED THROUGH LIDAR POINTS

(71) Applicant: Vueron Technology Co., Ltd., Seoul (KR)

(72) Inventors: Chang Hwan CHUN, Seoul (KR); Sung Oh PARK, Gyeonggi-do (KR)

(21) Appl. No.: 18/503,395

(22) Filed: Nov. 7, 2023

(30) Foreign Application Priority Data
Nov. 9, 2022 (KR) 10-2022-0148400

(51) Int. Cl. G06T 7/20; G01S 17/89; G06T 7/70; G06V 10/762; G06V 10/764

(52) U.S. Cl. CPC G06T 7/20; G01S 17/89; G06T 7/70; G06V 10/762; G06V 10/764; G06T 2207/30242

(57) ABSTRACT

A method of tracking objects detected through light detection and ranging (LiDAR) points can include, when two or more objects are moved in a previous frame and classified as one object in a current frame, clustering LiDAR points in the current frame into a plurality of clusters, finding center points of the plurality of clusters in the current frame, matching center points of the two or more objects in the previous frame with the center points of the plurality of clusters in the current frame, and updating positions of the center points of the two or more objects according to the matching in the current frame.

### BACKGROUND

### 1. Field of the Invention

The present invention relates to a method and device for tracking objects detected through light detection and ranging (LiDAR) points, and more specifically, to a method and device for tracking objects detected through LiDAR points that are robust to combination and separation for continuous accurate tracking of objects.

### 2. Discussion of Related Art

Light detection and ranging (LiDAR) sensors are sensors that use light in the form of pulsed laser to generate maps of objects and the surrounding environment thereof. LiDAR sensors may be used in various fields of autonomous vehicles, mobile robots, and the like.

FIG. 1 illustrates frames for describing a method of tracking objects detected through LiDAR points according to the related art.

Referring to FIG. 1, LiDAR points that may be generated through a LiDAR sensor may be recognized in an N^{th} frame which is a current frame 1, wherein N is a natural number.

The LiDAR points may be segmented to recognize objects in the N^{th} frame which is the current frame 1. Conventional well-known methods (for example, model fitting, boundary-based, graph-based, region-based, and attributes-based methods) may be used to segment the LiDAR points (S1). When the LIDAR points are segmented, a three-dimensional (3D) bounding boxes are marked in a current frame 3. One segment may be recognized as one object.

In order to determine to which object of the current frame 3 an object (for example, an object A) of a previous frame 5 corresponds, the current frame 3 in which the LiDAR points are segmented overlaps an (N−1)^{th} frame, which is the previous frame 5 (S2).

In order to determine to which object of the current frame 3 an object (for example, the object A) of the previous frame 5 corresponds, a segment tracking algorithm may be applied to a current frame 7 overlapping the previous frame 5 (S3).

As a result of applying the segment tracking algorithm, objects may be annotated in a current frame 9. For example, in the current frame 9, objects may be annotated with letters “A” “B,” “C,” and “D.”

After the annotating in the current frame 9, types of objects (for example, vehicles or pedestrians) may be determined (S4).

FIG. 2 illustrates frames for describing a method of tracking objects detected through LiDAR points according to the related art.

Referring to FIGS. 1 and 2, in a previous frame 5, objects may be annotated with letters “A,” “B,” “C,” and “D.” In the previous frame 5, arrows indicate trajectories. Although a bounding box in FIG. 2 is expressed as a two-dimensional (2D) bounding box, it should be actually understood that the bounding box is a 3D bounding box.

In a current frame 7, the current frame 7 overlap the previous frame 5 (S2).

Dotted bounding boxes represent bounding boxes of objects in the previous frame 5. In the current frame 7, objects have not yet been annotated.

A segment tracking algorithm may be applied to annotate the objects in the current frame 7 (S3). Similarity scores may be used as conventional segment tracking algorithms. The similarity score means that the bounding boxes of the objects in the previous frame 5 are compared with the bounding boxes of the objects in the current frame 7, and a degree of similarity therebetween is expressed as a score.

Korean Patent Publication No. 10-2022-0041485 (Apr. 1, 2022), disclosed is a technique in which a correlation index between a current representative point and a previous representative point of each of a plurality of segment boxes is calculated, and objects in a previous frame 5 are matched with objects in a current frame 7 according to the correlation index.

After the segment tracking algorithm is applied, objects in a current frame 9 may be annotated.

FIG. 3 illustrates frames for describing a method of tracking objects detected through LiDAR points according to the related art. FIG. 3 is similar to FIG. 2.

Referring to FIGS. 1 and 3, in order to calculate a similarity score, objects “A,” “B,” and “C” in a previous frame 5 are compared with objects 1, 2, and 3 in a current frame 7. For example, the object 1 in the current frame 7 is compared with the objects “A,” “B,” and “C” in the previous frame 5. The object 2 in the current frame 7 is compared with the objects “A,” “B,” and “C” in the previous frame 5. The object 3 in the current frame 7 is compared with the objects “A,” “B,” and “C” in the previous frame 5. In the current frame 7, 1, 2, and 3 are reference numbers assigned to describe the similarity score.

According to the similarity score, the objects 1, 2, and 3 in a current frame 9 may be annotated with letters “A,” “B,” and “C.”

FIG. 4 illustrates frames for describing a method of tracking objects detected through LiDAR points according to the related art.

Referring to FIGS. 1 and 4, objects “A,” “B,” and “C” in a previous frame 5 are moved and classified as one object X in a current frame 7. By using conventional well-known methods (for example, model fitting, boundary-based, graph-based, region-based, and attributes-based methods), LiDAR points in the current frame 7 are classified as one segment, that is, the object X. Since the objects “A,” “B,” and “C” are clustered close to each other, the objects “A,” “B,” and “C” are classified as one object rather than three objects in the current frame 7. In this case, the size of a bounding box also changes. Since three objects are gathered together, the size of the bounding box increases. The bounding box in the current frame 7 has not yet been annotated, but is arbitrarily denoted as “X” for convenience of description.

In the current frame 7, the current frame 7 overlaps the previous frame 5 (S2).

A segment tracking algorithm may be applied to annotate the object X in the current frame 7 (S3).

The objects “A,” “B,” and “C” in the previous frame 5 are compared with the object X in the current frame 7 to calculate similarity scores. It is assumed that the similarity score between the object “A” in the previous frame (5) and the object X in the current frame 7 is the highest, in a current frame 9, the object X may be annotated with the letter “A.”

In this case, according to the related art, history information about the object “B” and the object “C” in the previous frame 5 is deleted in the current frame 7. In paragraph number of Korean Patent Publication No. 10-2022-0041485 (Apr. 1, 2022), it is described that “when an associated segment box does not exist, history information about an m^{th} channel for which the associated segment box does not exist may be deleted.” That is, according to Korean Patent Publication No. 10-2022-0041485 (Apr. 1, 2022), since the similarity score between the object “B” in the previous frame 5 and the object X in the current frame 7 and the similarity score between the object “C” in the previous frame 5 and the object X in the current frame 7 are not the highest, history information about object “B” and the object “C” is deleted. The history information includes position information and speed information about the object “B” and the object “C” in the previous frame 5.

It is assumed that objects “D” and “E in a next frame 8 correspond to the objects “B” and “C” in the previous frame 5. However, according to the related art, the history information about the object “B” and the object “C” in the previous frame 5 is deleted in the current frame 7, and thus, in the next frame 8, the objects are not annotated with the letter “B or “C”, but with another letter “D” or “E.” That is, the related art has a problem in that tracking of the objects “B” and “C” in the previous frame 5 is lost in the next frame 8. The present invention is intended to solve this problem.

### RELATED ART DOCUMENTS

### Patent Documents

(Patent Document 0001) Korean Patent Publication No. 10-2022-0041485 (Apr. 1, 2022)

### SUMMARY OF THE INVENTION

The present invention is directed to providing a method and device for tracking objects detected through light detection and ranging (LiDAR) points that are robust to combination and separation for continuous accurate tracking of objects.

According to an aspect of the present invention, there is provided a method of tracking objects detected through LiDAR points, the method including, when two or more objects are moved in a previous frame and classified as one object in a current frame, clustering LiDAR points in the current frame into a plurality of clusters equal to the number of objects counted in the previous frame, finding center points of the plurality of clusters in the current frame, matching center points of the two or more objects in the previous frame with the center points of the plurality of clusters in the current frame, and updating positions of the center points of the plurality of clusters according to the matching in the current frame.

The method may further include classifying the LiDAR points into the two or more objects in the previous frame, and classifying the two or more objects as one object in the current frame.

The method may further include calculating similarity scores between the one object classified in the current frame and each of the two or more objects in the previous frame, storing a position of a center point of an object in the previous frame corresponding to a highest similarity score among the similarity scores in the current frame, and storing a position of a center point of an object in the previous frame corresponding to a remaining similarity score excluding the highest similarity score among the similarity scores in the current frame.

The method may further include assigning an ID of the object in the previous frame corresponding to the highest similarity score as an ID of the one object classified in the current frame.

The method may further include assigning a first sub-ID to the object in the previous frame corresponding to the highest similarity score among the similarity scores in the current frame, and assigning a second sub-ID to the object in the previous frame corresponding to the remaining similarity score excluding the highest similarity score among the similarity scores in the current frame.

The first sub-ID may include an ID of the object in the previous frame corresponding to the highest similarity score among the similarity scores.

The second sub-ID may include an ID of the object in the previous frame corresponding to the remaining similarity score excluding the highest similarity score among the similarity scores.

The method may further include, when the one object is classified into the two or more objects in a next frame, assigning IDs to the two or more objects in the next frame according to the updated positions of the center points of the two or more objects in the current frame.

The IDs of the two or more objects in the next frame may correspond to IDs of the two or more objects in the previous frame.

The clustering of the LiDAR points in the current frame into the plurality of clusters may include counting the number of objects in the previous frame, and clustering the LiDAR points in the current frame into the plurality of clusters equal to the number of objects counted in the previous frame.

The matching of the center points of the two or more objects in the previous frame with the center points of the plurality of clusters in the current frame may include calculating a distance between each of the center points of the two or more objects in the previous frame and each of the center points of the plurality of clusters in the current frame, and matching points having shortest distances among the calculated distance.

According to another aspect of the present invention, there is provided a device including a processor configured to execute instructions, and a memory configured to store the instructions.

The instructions may be implemented to, when two or more objects are moved in a previous frame and classified as one object in a current frame, cluster LDAR points in the current frame into a plurality of clusters equal to the number of objects counted in the previous frame, find center points of the plurality of clusters in the current frame, match center points of the two or more objects in the previous frame with the center points of the plurality of clusters in the current frame, and update positions of the center points of the two or more objects according to the matching in the current frame.

### BRIEF DESCRIPTION OF THE DRAWINGS

A detailed description of each drawing is provided to facilitate a more thorough understanding of the drawings referenced in the detailed description of the present invention.

FIGS. 1 to 4 illustrate frames for describing a method of tracking objects detected through light detection and ranging (LiDAR) points according to the related art.

FIG. 5 is a block diagram of a system for tracking objects through LiDAR points according to an embodiment of the present invention.

FIG. 6 illustrates frames for describing a method of tracking objects detected through LiDAR points according to an embodiment of the present invention.

FIGS. 7 and 8 are flowcharts for describing a method of tracking objects detected through LiDAR points according to an embodiment of the present invention.

FIG. 9 illustrates frames for describing the application of a method of tracking objects detected through LiDAR points according to an embodiment of the present invention.

FIG. 10 illustrates frames for describing a method of tracking objects detected through LiDAR points according to an embodiment of the present invention.

### DETAILED DESCRIPTION OF EXEMPLARY EMBODIMENTS

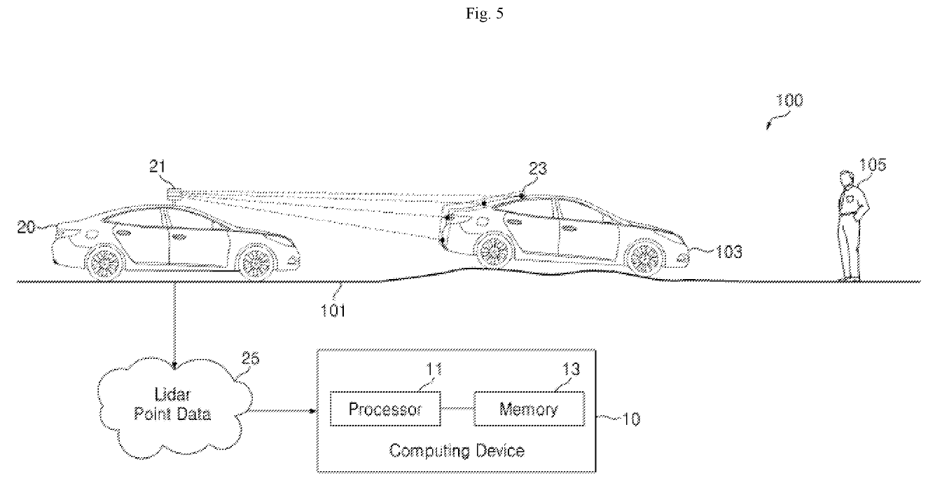

FIG. 5 is a block diagram of a system for tracking objects through light detection and ranging (LiDAR) points according to an embodiment of the present invention.

Referring to FIG. 5, a system 100 for tracking objects through LiDAR points 23 is a system for tracking objects detected through the LiDAR points 23.

A vehicle 103, a pedestrian 105, or the like may be an object.

The system 100 for tracking the objects detected through the LiDAR points 23 may include a vehicle 20.

The system 100 for tracking the objects detected through the LiDAR points 23 includes a computing device 10.

The vehicle 20 includes a LiDAR sensor 21. In addition, the vehicle 20 may include the computing device 10. The LiDAR sensor 21 generates LiDAR point data 25 including the LiDAR points 23. The LiDAR points 23 are a plurality of three-dimensional (3D) points.

As the vehicle 20 moves, the LiDAR sensor 21 installed in the vehicle 20 generates the LiDAR point data 25 about various surrounding environments of the vehicle 20. The LiDAR point data 25 includes the LiDAR points 23. That is, the LiDAR point data 25 refers to the LiDAR points 23. The LiDAR points 23 are 3D point clouds, LiDAR points, or point clouds. According to embodiments, the LiDAR sensor 21 may be installed in various objects such as fixed objects or robots for sensing.

The computing device 10 may be implemented as a hardware module combined with other hardware inside the vehicle 20 or as an independent hardware device. For example, the computing device 10 may be implemented in an electronic control unit (ECU) of the vehicle 20. In addition, the computing device 10 may be implemented as an external electronic device such as a computer, a laptop, personnel computer (PC), a server, or a tablet PC.

The computing device 10 includes a processor 11 and memory 13. The processor 11 executes instructions for tracking objects detected through the LiDAR points 23. The memory 13 stores the instructions.

The processor 11 receives the LiDAR point data 25 including the LiDAR points 23 from the LiDAR sensor 21.

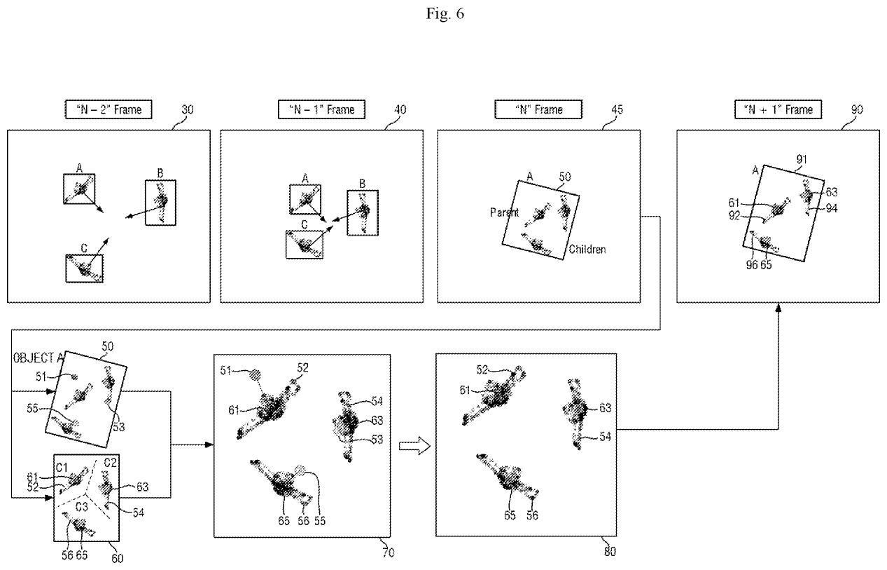

FIG. 6 illustrates frames for describing a method of tracking objects detected through LiDAR points according to an embodiment of the present invention.

Referring to FIGS. 5 and 6, the processor 11 receives the LiDAR point data 25 from the LiDAR sensor 21 and recognizes the LiDAR points 23 included in the LiDAR point data 25.

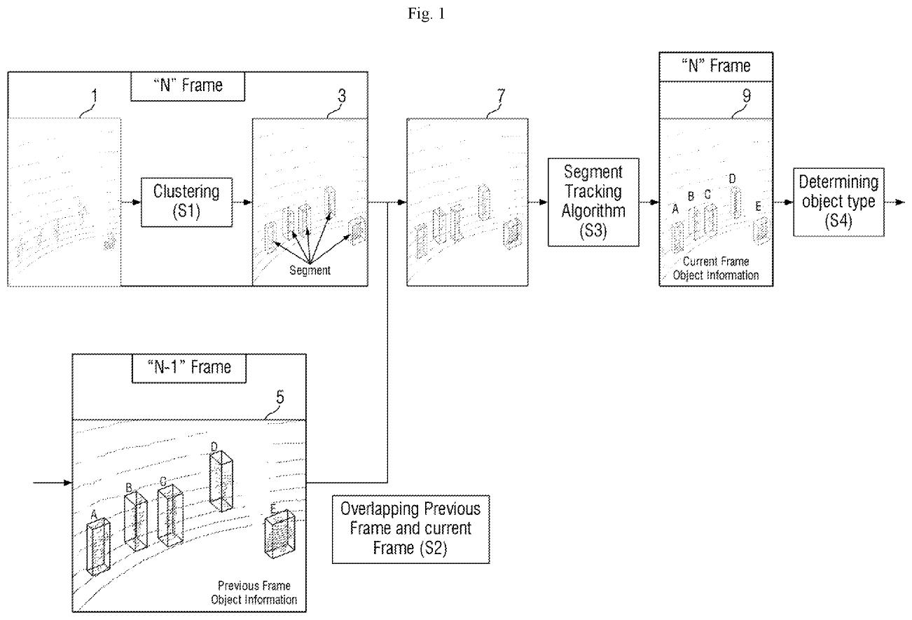

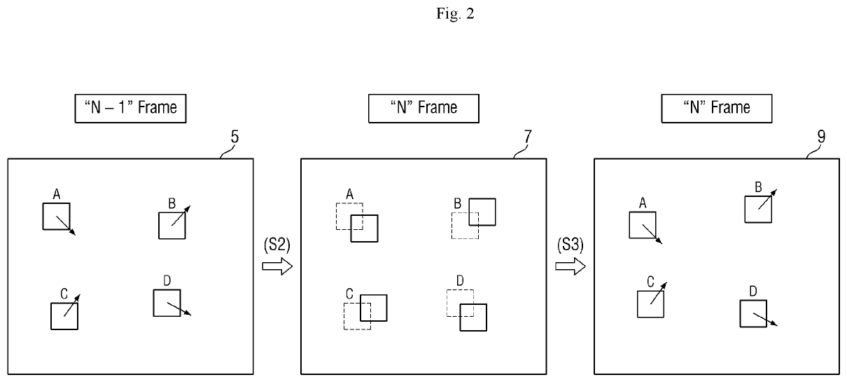

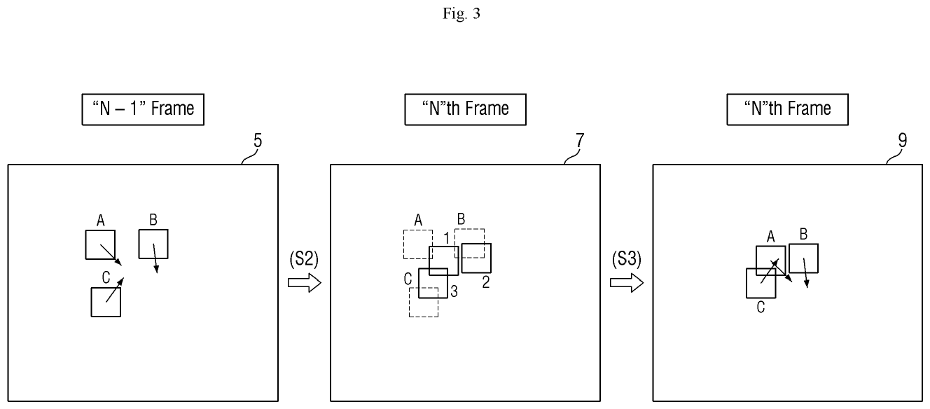

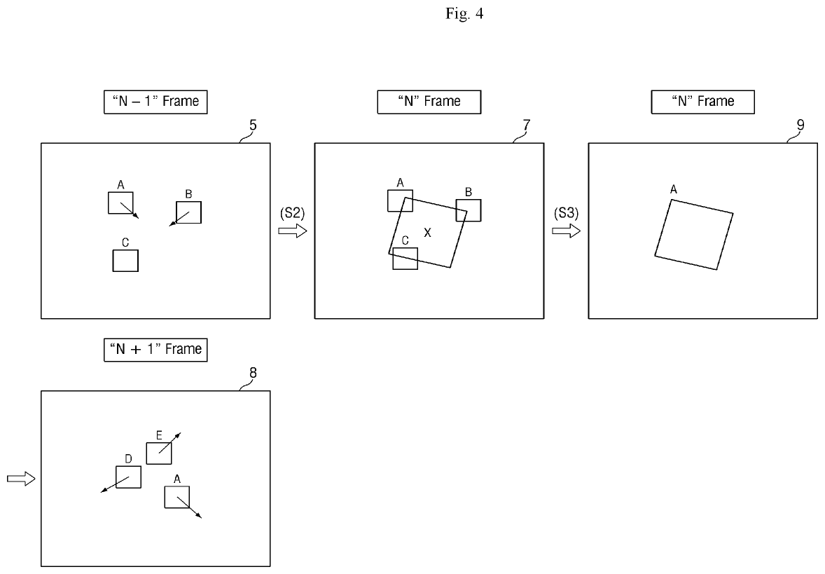

The processor 11 segments the LiDAR points 23 to recognize objects (for example, the vehicle 103 or the pedestrian 105) in an (N−2)^{th} frame (N is a natural number). For a segmentation operation, well-known conventional methods described in FIG. 1 are used. Objects may be recognized by segmenting the LiDAR points 23. In this case, the LIDAR points 23 are 3D point clouds generated in an (N−2)^{th} frame 30.

A frame refers to a 3D map of a scene generated from the LiDAR points 23. The system 100 for tracking the objects detected through the LiDAR points 23 may have a frame rate between 10 frames per second and 30 frames per second.

When the LiDAR points 23 are segmented, the processor 11 marks 3D bounding boxes in the (N−2)^{th} frame 30. One segment may be recognized as one object. An object may be a vehicle, a pedestrian, or an obstacle.

The processor 11 stores coordinates of each vertex of the bounding boxes and widths, lengths, and heights of the bounding boxes in the (N−2)^{th} frame 30 in a storage space (for example, the memory 13). In addition, the processor 11 stores x, y, and z coordinates of the LiDAR points 23 included in the bounding boxes in the (N−2)^{th} frame 30 in the storage space (for example, the memory 13). In FIG. 6, the bounding box is expressed as a two-dimensional (2D) box, but is actually expressed as a 3D bounding box.

The processor 11 may annotate the recognized objects. For example, the processor 11 may annotate the objects in the (N−2)^{th} frame 30 with letters “A,” “B,” and “C.” According to embodiments, the annotation may be made in various ways using numbers or a combination of letters and numbers.

After the annotation is made in the (N−2)^{th} frame 30, the processor 11 may determine types of the objects (for example, vehicles pedestrians or obstacles).

The processor 11 stores IDs, ages, speeds, trajectories, and types of the objects in the (N−2)^{th} frame 30 in the storage space (for example, the memory 13).

The ID refers to letters for objects (for example, “A,” “B,” and “C”). Objects may be identified by the ID.

The age refers to the number of frames that continuously inherit the ID after the object is annotated.

The speed refers to the speed of each object. The trajectory refers to a trajectory along which the object has moved during any previous frames. Arrows refer to the trajectories in the (N−2)^{th} frame 30.

In the storage space (for example, the memory 13), the age, speed, trajectory, type, and position of the bounding box of the object may be stored for each frame.

The processor 11 segments the LiDAR points 23 to recognize objects in the (N−1)^{th} frame 40. In this case, the LIDAR points 23 are 3D point clouds generated in the (N−1)^{th} frame 40.

In order to determine to which object of the (N−1)^{th} frame 40 an object (for example, an object A) of the (N−2)^{th} frame 30 corresponds, the processor 11 causes the (N−2)^{th} frame 30, in which the LiDAR points 23 are segmented, to overlap the (N−1)^{th} frame 40.

In order to determine to which object of the (N−1)^{th} frame 40 the object (for example, the object A) of the (N−2)^{th} frame 30 corresponds, a segment tracking algorithm may be applied to the (N−1)^{th} frame 40 overlapping the (N−2)^{th} frame 30.

A similarity score may be used as the segment tracking algorithm. The similarity score means that bounding boxes of objects in the (N−2)^{th} frame 30 are compared with bounding boxes of objects in the (N−1)^{th} frame 40, and a degree of similarity therebetween is expressed as a score. According to the similarity score, the objects in the (N−1)^{th} frame 40 may be annotated with letters “A,” “B,” and “C.”

The processor 11 stores coordinates of each vertex of the bounding boxes and widths, lengths, and heights of the bounding boxes in the (N−1)^{th} frame 40 in the storage space (for example, the memory 13).

The processor 11 stores IDs, ages, speeds, trajectories, and types of the objects in the (N−1)^{th} frame 40 in the storage space (for example, the memory 13).

When two or more objects “A,” “B,” and “C” in a previous frame 40 move, the processor 11 may classify the two or more objects “A,” “B,” and “C” as one object in a current frame 45. The previous frame 40 refers to the (N−1)^{th} frame 40. The current frame 45 refers to an N^{th} frame 45.

The classification refers to segmentation. That is, the processor 11 may segment LiDAR points 52, 54, and 56 in the current frame 45 into one object. When the objects “A,” “B,” and “C” in the previous frame 40 are clustered close together, the processor 11 segments the LiDAR points 52, 54, and 56 in the current frame 45 into one object. When the LiDAR points 52, 54, and 56 in the current frame 45 are segmented into one object, a bounding box 50 corresponding to one object becomes larger than a bounding box in the previous frame 40.

The processor 11 calculates similarity scores between one object classified in the current frame 45 and each of the objects “A,” “B,” and “C” in the previous frame 40.

The processor 11 assigns an ID (for example, “A”) of an object in the previous frame 40 corresponding to the highest similarity score as an ID (for example, “A”) of one object classified in the current frame 45.

The processor 11 stores coordinates of each vertex of the bounding box 50 and a width, a length, and a height of the bounding box 50 in the current frame 45 in the storage space (for example, the memory 13). The processor 11 stores the ID (for example, “A”) of the object corresponding to the highest similarity score in the current frame 45, an age of the object (for example, “A”), a speed of the object (for example, “A”), a trajectory of the object (for example, “A”), and a type of the object (for example, “A”) in the storage space (for example, the memory 13).

Even in the related art, the ID, age, speed, trajectory, and type of the object “A” in the current frame 45 are stored in the storage space (for example, the memory 13). However, in the related art, IDs, ages, speeds, trajectories, and types of the objects “B” and “C” in the current frame 45 are not stored in the storage space (for example, the memory 13), but are deleted. The objects “B” and “C” are not objects corresponding to the highest similarity score. This is because there is no bounding box corresponding to the objects “B” and “C” in the current frame 45.

The processor 11 stores a position of a center point 51 of the object (for example, “A”) in the previous frame 40 corresponding to the highest similarity score among similarity scores in the current frame 45 in the storage space (for example, the memory 13). When the LiDAR points 23 are segmented in the previous frame 40, the position of the center point 51 may be calculated as an average value of the LiDAR points 23 included in a segment.

The processor 11 assigns the ID (for example, “A”) of the object in the previous frame 40 corresponding to the highest similarity score as a first sub-ID (for example, “A”). The first sub-ID is an ID different from the ID of the object. According to embodiments, a sub-ID may be made in various ways using numbers or a combination of letters and numbers.

In the current frame 45, the processor 11 stores the first sub-ID, an age, a speed, a trajectory, and a type of the object (for example, “A”) in the previous frame 40 in the storage space (for example, the memory 13). In addition, in the current frame 45, the processor 11 may store coordinates of each vertex, a width, a length, and a height of a bounding box of the object (for example, “A”) in the previous frame 40 in the storage space (for example, the memory 13).

The processor 11 stores positions of center points 53 and 55 of objects (for example, “B” and “C”) in the previous frame 40, which correspond to the remaining similarity scores excluding the highest similarity score among the similarity scores in the current frame 45, in the storage space (for example, the memory 13).

The processor 11 assigns IDs (for example, “B” and “C” of the objects in the previous frame 40 corresponding to the remaining similarity scores as second sub-IDs (for example, “B” and “C”).

In the current frame 45, the processor 11 stores the second sub-IDs, ages, speeds, trajectories, and types of the objects (for example, “B” and “C”) in the previous frame 40 in the storage space (for example, the memory 13). In the related art, in the current frame 45, the second sub-IDs of the objects (for example, “B” and “C”) in the previous frame 40 are not stored in the storage space (for example, memory 13).

In addition, in the current frame 45, the processor 11 may store coordinates of each vertex, widths, lengths, and heights of bounding boxes of the objects (for example, “B” and “C”) in the previous frame 40 in the storage space (for example, the memory 13).

The processor 11 stores the first sub-ID and the second sub-IDs of the objects “A,” “B,” and “C” in the current frame 45. In the current frame 45, the processor 11 stores history information about the objects “A,” “B,” and “C” in the previous frame 40 in the storage space (for example, the memory 13). The history information includes an age, a speed, a trajectory, a type, coordinates of a bounding box, a width of the bounding box, a length of the bounding box, a height of the bounding box, or the like in the previous frame 40. The first sub-ID may be called a parent, and the second sub-IDs may be called children.

The processor 11 clusters the LiDAR points 52, 54, and 56 in the current frame 45 into a plurality of clusters C1, C2, and C3. Clustering refers to a segmentation operation. That is, the processor 11 resegments the LiDAR points 52, 54, and 56 in the current frame 45 into a plurality of objects C1, C2, and C3. The LiDAR points 52, 54, and 56 in the current frame 45 are segmented into one object “A.” A first scale when the LiDAR points 52, 54, and 56 are segmented into one object “A” is different from a second scale when the LiDAR points 52, 54, and 56 are clustered into the plurality of clusters C1, C2, and C3. The second scale when the LiDAR points 52, 54, and 56 are clustered into the plurality of clusters C1, C2, and C3 is finer than the first scale when the LiDAR points 52, 54, and 56 are segmented into one object “A.” For example, in the case of the first scale, when a Euclidean distance between two LiDAR points is a first random distance (50 cm) or more, the two LiDAR points may be classified into different segments. On the other hand, in the case of the second scale, which is a fine scale, even when a Euclidean distance between two LiDAR points is a second random distance (20 cm) or more and the first random distance (50 cm) or less, the two LiDAR points may be classified into different segments. Accordingly, the LiDAR points 52, 54, and 56 may be clustered into the plurality of clusters C1, C2, and C3.

When the first scale when the LiDAR points 52, 54, and 56 are segmented into one object “A” is the same as the fine second scale when the LiDAR points 52, 54, and 56 are clustered into the plurality of clusters C1, C2, and, an amount of calculation increases, and thus the burden on the processor 11 increases. However, in the present invention, only when the LiDAR points 52, 54, and 56 are segmented into one object “A,” the LiDAR points 52, 54, and 56 are clustered into the plurality of clusters C1, C2, and C3 in a fine scale, and thus the burden on the processor 11 may be reduced.

In the related art, an operation of clustering the LiDAR points 52, 54, and 56 into the plurality of clusters C1, C2, and C3 is not performed.

In order to cluster the LiDAR points 52, 54, and 56 into the plurality of clusters C1, C2, and C3, the processor 11 counts the number (for example, 3) of objects in the previous frame 40.

The processor 11 may cluster the LiDAR points 52, 54, and 56 in the current frame 45 into a plurality of clusters (for example, C1, C2, and C3) equal to the number (for example, 3) of objects counted in the previous frame 40. AK-means clustering algorithm may be used to cluster the LiDAR points 52, 54, and 56 into the plurality of clusters (for example, C1, C2, and C3). Reference numeral 50 denotes a bounding box for the object “A” generated in the current frame 45. Reference numeral 60 denotes a virtual bounding box. The virtual bounding box refers to a box illustrated for convenience of description. Actually, the virtual bounding box may not be present.

An algorithm (for example, a region-based algorithm) when the LiDAR points 52, 54, and 56 in the current frame 45 are classified as one object “A” may be the same as an algorithm (for example, a region-based algorithm) when the LiDAR points 52, 54, and 56 are reclassified into a plurality of clusters (for example, C1, C2, and C3).

According to embodiments, an algorithm (for example, a region-based algorithm) when the LiDAR points 52, 54, and 56 in the current frame 45 are classified as one object “A” may be different from an algorithm (for example, a K-means clustering algorithm) when the LiDAR points 52, 54, and 56 are reclassified into a plurality of clusters (for example, C1, C2, and C3).

The processor 11 finds center points 61, 63, and 65 of the plurality of clusters (for example, C1, C2, and C3) in the current frame 45. That is, the processor 11 finds positions of the center points 61, 63, and 65 of the plurality of clusters (for example, 1, C2, and C3) in the current frame 45. The positions of the center points 61, 63, and 65 may be calculated as an average value of the LIDAR points 52, 54, and 56 included in the clusters (for example, C1, C2, and C3).

The processor 11 matches the center points 51, 53, and 55 of the two or more objects in the previous frame 40 with the center points 61, 63, and 65 of the plurality of clusters C1, C2, and C3 in the current frame 45. The matching refers to a process of finding the center points 61, 63, and 65 of the clusters C1, C2, and C3 that correspond to the center points 51, 53, and 55 of the objects. In order to find the center points 61, 63, and 65 of the clusters C1, C2, and C3 corresponding to the center points 51, 53, and 55 of the objects, Euclidean distances between the center points 51, 53, and 55 of the objects and the center points 61, 63, and 65 of the clusters C1, C2, and C3 may be calculated. Points, which have the shortest Euclidean distances among the Euclidean distances between the center points 51, 53, and 55 of the objects and the center points 61, 63, and 65 of the clusters C1, C2, and C3, are recognized as corresponding points (for example, 51 and 61, 53 and 63, and 55 and 65).

The center point 51 of the object in the previous frame 40 corresponds to the center point 61 of the cluster C1 in the current frame 45 corresponding thereto. The center point 53 of the object in the previous frame 40 corresponds to the center point 63 of the cluster C2 in the current frame 45 corresponding thereto. The center point 55 of the object in the previous frame 40 corresponds to the center point 65 of the cluster C3 in the current frame 45 corresponding thereto.

Reference numeral 70 denotes a virtual bounding box. The virtual bounding box refers to a box illustrated for convenience of description. Actually, the virtual bounding box may not be present. The matching results of the center points 51, 53, and 55 of the objects in the virtual bounding box 70 and the center points 61, 63, and 65 of the plurality of clusters C1, C2, and C3 are shown. The LiDAR points 52, 54, and 56 are enlarged and shown in the virtual bounding box 70.

The positions of the center points 51, 53, and 55 of the two or more objects in the previous frame 40 may be different from the positions of the center points 61, 63, and 65 of the plurality of clusters C1, C2, and C3 in the current frame 45. This is because the LiDAR points 52, 54, and 56 have moved in the current frame 45. Arrows in the virtual bounding box 70 indicate movement of the center points.

The center point 51 in the previous frame 40 has moved to the center point 61 in the current frame 45. The center point 53 in the previous frame 40 has moved to the center point 63 in the current frame 45. The center point 55 in the previous frame 40 has moved to the center point 65 in the current frame 45.

The processor 11 updates the positions of the center points 51, 53, and 55 of the two or more objects according to the matching in a current frame 90.

The updating means that the positions of the center points 51, 53, and 55 of the two or more objects in the current frame 90 are set to the positions of the center points 61, 63, and 65 of the plurality of clusters C1, C2, and C3.

Reference numeral 80 denotes a virtual bounding box. The virtual bounding box refers to a box illustrated for convenience of description. Actually, the virtual bounding box may not be present. The LiDAR points 52, 54, and 56 are enlarged and shown in the virtual bounding box 80.

The positions of the LiDAR points 52, 54, and 56 and the updated center points 61, 63, and 65 in the current frame 90 are shown.

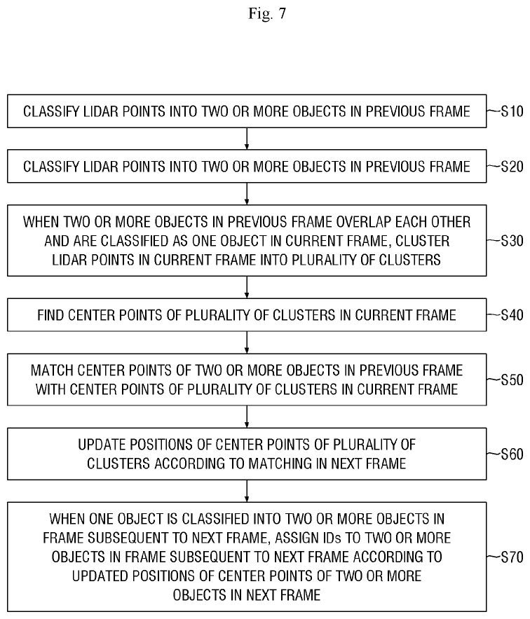

FIG. 7 is a flowchart for describing a method of tracking objects detected through LiDAR points according to an embodiment of the present invention.

Referring to FIGS. 5 to 7, the processor 11 classifies LiDAR points 23 into two or more objects “A,” “B,” and “C” in a previous frame 40, which is an (N−1)^{th} frame (S10). That is, the processor 11 segments the LiDAR points 23 to recognize objects in the previous frame 40, which is the (N−1)^{th} frame.

When two or more objects “A,” “B,” and “C” in the previous frame 40 move, the processor 11 may classify the two or more objects “A,” “B,” and “C” as one object in a current frame 45 (S20).

The processor 11 clusters the LiDAR points 52, 54, and 56 in the current frame 45 into a plurality of clusters C1, C2, and C3 (S30). Specifically, the processor 11 counts the number (for example, 3) of objects in the previous frame 40. The processor 11 clusters the LiDAR points 52, 54, and 56 in the current frame 45 into a plurality of clusters C1, C2, and C3 equal to the number (for example, 3) of objects counted in the previous frame 40.

The processor 11 finds center points 61, 63, and 65 of the plurality of clusters C1, C2, and C3 in the current frame 45 (S40).

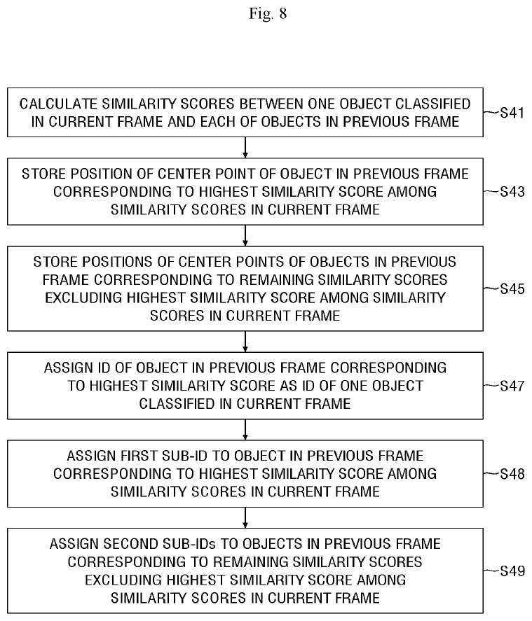

FIG. 8 is a flowchart for describing a method of tracking objects detected through LiDAR points according to an embodiment of the present invention.

Referring to FIGS. 5 to 8, the processor 11 calculates similarity scores between one object classified in a current frame 45 and each of objects “A,” “B,” and “C” in a previous frame 40 (S41). Specifically, the processor 11 calculates similarity scores between a bounding box 50 corresponding to one object classified in the current frame 45 and bounding boxes corresponding to the objects “A,” “B,” and “C” in the previous frame 40.

The processor 11 stores a position of a center point of the object “A” in the previous frame 40 corresponding to the highest similarity score among the similarity scores in the current frame 45 (S43). That is, in the current frame 45, the processor 11 stores a position of a center point 51 of the object “A” in the previous frame 40 in the storage space (for example, the memory 13).

The processor 11 stores positions of center points 53 and 55 of objects “B” and “C” in the previous frame 40, which correspond to the remaining similarity scores excluding the highest similarity score among the similarity scores, in the current frame 45 (S45). That is, in the current frame 45, the processor 11 stores the positions of the center points 53 and 55 of the objects “B” and “C” in the previous frame 40 in the storage space (for example, the memory 13).

The processor 11 assigns an ID (for example, “A”) of an object in the previous frame 40 corresponding to the highest similarity score as an ID (for example, “A”) of one object classified in the current frame 45 (S47).

In the current frame 45, the processor 11 assigns the ID of the object in the previous frame 40 corresponding to the highest similarity score among the similarity scores as a first sub-ID (for example, “A”) (S48).

The first sub-ID (for example, “A”) includes the ID (for example, “A”) of the object in the previous frame 40 corresponding to the highest similarity score among the similarity scores.

According to embodiments, the first sub-ID may be different from the ID of the object. For example, the first sub-ID may be a lowercase letter “a,” and the ID of the object may be an uppercase letter “A.”

The processor 11 assigns IDs of objects in the previous frame 40 corresponding to the remaining similarity scores excluding the highest similarity score among the similarity scores in the current frame 45 as second sub-IDs (for example, “B” and “C”) (S49).

The second sub-IDs (for example, “B” and “C”) includes the IDs (for example, “B and “C”) of the objects in the previous frame 40 corresponding to the remaining similarity scores excluding the highest similarity score among the similarity scores.

According to embodiments, the second sub-IDs may be different from the IDs (for example, “B” and “C”) of the objects in the previous frame 40. For example, the second sub-IDs may be lowercase letters “b” and “c,” and the IDs of the objects in the previous frame 40 may be uppercase letters “B” and “C.”

Referring to FIG. 7, the processor 11 matches the center points 51, 53, and 55 of the two or more objects in the previous frame 40 with the center points 61, 63, and 65 of the plurality of clusters C1, C2, and C3 in the current frame 45 (S50).

The processor 11 updates the positions of the center points 51, 53, and 55 of the two or more objects according to the matching in a current frame 90 (S60).

When one object is classified into two or more objects in a next frame (not shown), the processor 11 assigns IDs to the two or more objects in the next frame according to the updated positions of the center points of the two or more objects in the current frame 90 (S70).

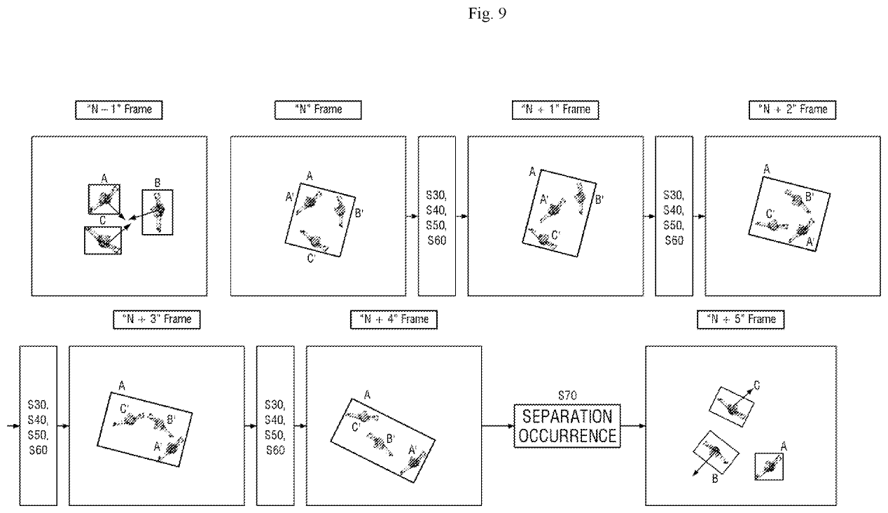

FIG. 9 illustrates frames for describing the application of a method of tracking objects detected through LiDAR points according to an embodiment of the present invention.

Referring to FIGS. 5 and 7 to 9, the processor 11 updates positions of center points A′, B′; and C′ of two or more objects according to the matching in an N^{th} frame.

The processor 11 performs operations S30 to S60 of FIG. 7 in an (N+1)^{th} frame to update the positions of the center points A′, B,′ and C′ of the two or more objects.

It is assumed that LiDAR points from (N+2)^{th} to (N+4)^{th} frames are segmented into one object. The processor 11 performs operations S30 to S60 of FIG. 7 in each of the (N+2)^{th} to (N+4)^{th} frames to update the positions of the center points A′, B′, and C′ of the two or more objects.

When the LiDAR points in an (N+5)^{th} frame move, the processor 11 may segment the LiDAR points into three objects.

When one object is classified into three objects in the (N+5)^{th} frame, the processor 11 assigns IDs to three objects in the (N+5)^{th} frame according to updated positions of center points of the three objects in the (N+4)^{th} frame.

The processor 11 classifies the LiDAR points into three objects in the (N+5)^{th} frame. The processor 11 calculates the center points of the three objects in the (N+5)^{th} frame.

The processor 11 compares the positions of the center points of the objects in the (N+4)^{th} frame with the positions of the center points in the (N+5)^{th} frame. Specifically, the processor 11 calculates distances between the positions of the center points of the objects in the (N+4)^{th} frame and the positions of the center points in the (N+5)^{th} frame.

The processor 11 matches the points, which have the shortest distances among the distances between the positions of the center points of the objects in the (N+4)^{th} frame and the positions of the center points in the (N+5)^{th} frame.

The processor 11 may annotate the objects in the (N+5)^{th} frame according to the corresponding points. For example, the processor 11 may annotate the objects in the (N+5)^{th} frame with letters “A,” “B,” and “C.”

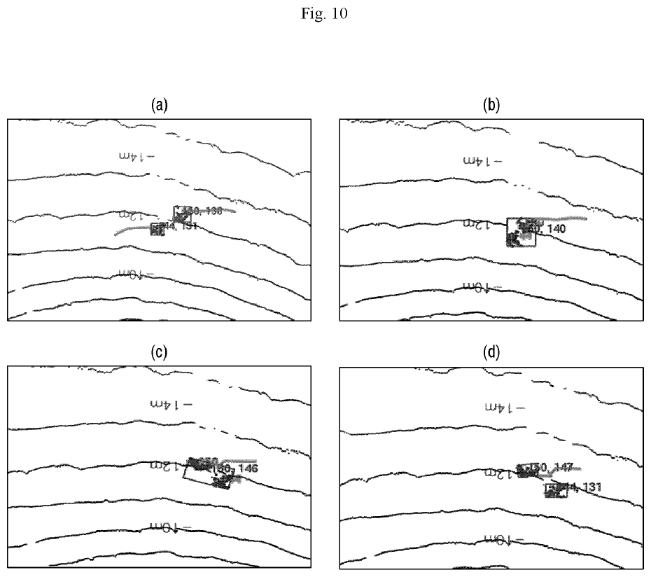

FIG. 10 illustrates frames for describing a method of tracking objects detected through LiDAR points according to an embodiment of the present invention. FIGS. 10A, 10B, 10C, and 10D illustrate frames in chronological order. FIG. 10A illustrates a previous frame, and FIG. 10B illustrates a more recent frame than that of FIG. 10A. FIG. 10C illustrates a more recent frame than that of FIG. 10B. FIG. 10C illustrates the most recent frame. The frames of FIGS. 10A, 10B, 10C, and 10D are not consecutive frames.

Referring to FIGS. 5 and 10A, the processor 11 segments LiDAR points into two objects. In FIG. 10A, bounding boxes corresponding to two objects, trajectories, IDs, and the number of persisting frames are shown. For example, among “150” and “138” in FIG. 10A, 150 denotes an ID, and 138 denotes the number of persisting frames. An object with the ID 150 has persisted from 138 previous frames. That is, the object with the ID 150 has been tracked from 138 previous frames. In FIG. 10A, a line connected to the bounding box represents a trajectory.

Referring to FIGS. 5 and 10B, the processor 11 segments LiDAR points into one object. The processor 11 calculates similarity scores between a bounding box in the frame shown in FIG. 10B and the bounding boxes in the frame shown in FIG. 10A. Assuming that the similarity score between the bounding box with the ID 150 in FIG. 10A and the bounding box in FIG. 10B is the highest, the processor 11 assigns 150 as the ID of the bounding box in FIG. 10B.

The processor 11 may cluster the LiDAR points in the frame of FIG. 10B into two clusters equal to the number (for example, 2) of objects counted in the frame of FIG. 10A.

The processor 11 assigns an ID of an object in the frame of FIG. 10A corresponding to the highest similarity score among the similarity scores in the frame of FIG. 10B as a first sub-ID (for example, “150”).

The processor 11 assigns an ID of an object in the frame of FIG. 10A corresponding to the remaining similarity score excluding the highest similarity score among the similarity scores in the frame FIG. 10B as a second sub-ID (for example, “144”).

The processor 11 finds center points of the two clusters in the frame of FIG. 10B.

The processor 11 matches the center points of two objects in the frame of FIG. 10A with center points of two clusters in the frame of FIG. 10B.

The processor 11 updates the positions of the center points of the two objects according to the matching in the frame of FIG. 10B.

Referring to FIGS. 5 and 10C, the LiDAR points have moved, but are still segmented into one object. Similar to FIG. 10B, the processor 11 updates the positions of the center points of the two objects according to the matching in the frame of FIG. 10C.

Referring to FIGS. 5 and 10D, the LiDAR points have moved. Therefore, the processor 11 segments the LiDAR points into two objects.

The processor 11 may assign IDs to the two objects segmented in the frame of FIG. 10D using the positions of the center points of the clusters in the frame of FIG. 10C. The IDs of the objects assigned in the frame of FIG. 10D are “50” and “144,” which correspond to the IDs of the objects assigned in the frame of FIG. 10A.

With a method and device for tracking objects detected through LiDAR points according to an embodiment of the present invention, when two or more objects in the previous frame are moved in the current frame and classified as one object, by storing the information on objects in the previous frame in the current without deleting it, it is possible to accurately track the objects even if one object is separated into two or more objects.

The present invention has been described with reference to embodiments shown in the drawings, but this is merely illustrative, and those skilled in the art will understand that various modifications and other equivalent embodiments are possible therefrom. Therefore, the true scope of technical protection of the present invention should be determined by the technical spirit of the attached claims.

What is claimed is:

1. A method of tracking objects detected through light detection and ranging (LiDAR) points, the method comprising:
when two or more objects are moved in a previous frame and classified as one object in a current frame, clustering LiDAR points in the current frame into a plurality of clusters;
finding center points of the plurality of clusters in the current frame;
matching center points of the two or more objects in the previous frame with the center points of the plurality of clusters in the current frame; and
updating positions of the center points of the two or more objects according to the matching in the current frame.

2. The method of claim 1, further including classifying the LiDAR points into the two or more objects in the previous frame, and
classifying the two or more objects as one object in the current frame.

3. The method of claim 1, further including calculating similarity scores between the one object classified in the current frame and each of the two or more objects in the previous frame,
storing a position of a center point of an object in the previous frame corresponding to a highest similarity score among the similarity scores in the current frame, and
storing a position of a center point of an object in the previous frame corresponding to a remaining similarity score excluding the highest similarity score among the similarity scores in the current frame.

4. The method of claim 3, further including assigning an ID of the object in the previous frame corresponding to the highest similarity score as an ID of the one object classified in the current frame.

5. The method of claim 3, further including assigning a first sub-ID to the object in the previous frame corresponding to the highest similarity score among the similarity scores in the current frame, and
assigning a second sub-ID to the object in the previous frame corresponding to the remaining similarity score excluding the highest similarity score among the similarity scores in the current frame.

6. The method of claim 5, wherein the first sub-ID includes an ID of the object in the previous frame corresponding to the highest similarity score among the similarity scores, and
the second sub-ID includes an ID of the object in the previous frame corresponding to the remaining similarity score excluding the highest similarity score among the similarity scores.

7. The method of claim 1, further including, when the one object is classified into the two or more objects in a next frame, assigning IDs to the two or more objects in the next frame according to the updated positions of the center points of the two or more objects in the current frame.

8. The method of claim 7, wherein the IDs of the two or more objects in the next frame correspond to IDs of the two or more objects in the previous frame.

9. The method of claim 1, wherein the clustering of the LiDAR points in the current frame into the plurality of clusters includes counting the number of objects in the previous frame, and clustering the LiDAR points in the current frame into the plurality of clusters equal to the number of objects counted in the previous frame.

10. The method of claim 1, wherein the matching of the center points of the two or more objects in the previous frame with the center points of the plurality of clusters in the current frame includes calculating a distance between each of the center points of the two or more objects in the previous frame and each of the center points of the plurality of clusters in the current frame, and matching points having shortest distances among the calculated distance.

11. A device comprising:
a processor configured to execute instructions; and
a memory configured to store the instructions,
wherein the instructions are implemented to, when two or more objects are moved in a previous frame and classified as one object in a current frame, cluster light detection and ranging (LDAR) points in the current frame into a plurality of clusters, find center points of the plurality of clusters in the current frame, match center points of the two or more objects in the previous frame with the center points of the plurality of clusters in the current frame, and update positions of the center points of the two or more objects according to the matching in the current frame.

12. The device of claim 11, further including instructions implemented to classify the LiDAR points into the two or more objects in the previous frame and classify the two or more objects as one object in the current frame.

13. The device of claim 11, further including instructions implemented to calculate similarity scores between the one object classified in the current frame and each of the two or more objects in the previous frame, store a position of a center point of an object in the previous frame corresponding to a highest similarity score among the similarity scores in the current frame, and store a position of a center point of an object in the previous frame corresponding to a remaining similarity score excluding the highest similarity score among the similarity scores in the current frame.

14. The device of claim 13, further including instructions implemented to assign an ID of the object in the previous frame corresponding to the highest similarity score as an ID of the one object classified in the current frame.

15. The device of claim 13, further including instructions implemented to assign a first sub-ID to the object in the previous frame corresponding to the highest similarity score among the similarity scores in the current frame and assign a second sub-ID to the object in the previous frame corresponding to the remaining similarity score excluding the highest similarity score among the similarity scores in the current frame.

16. The device of claim 15, wherein the first sub-ID includes an ID of the object in the previous frame corresponding to the highest similarity score among the similarity scores, and
the second sub-ID includes an ID of the object in the previous frame corresponding to the remaining similarity score excluding the highest similarity score among the similarity scores.

17. The device of claim 11, further including instructions implemented to, when the one object is classified into the two or more objects in a next frame, assign IDs to the two or more objects in the next frame according to the updated positions of the center points of the two or more objects in the current frame.

18. The device of claim 17, wherein the IDs of the two or more objects in the next frame correspond to IDs of the two or more objects in the previous frame.

19. The device of claim 11, wherein the instructions implemented to cluster the LiDAR points in the current frame into the plurality of clusters are implemented to count the number of objects in the previous frame and cluster the LiDAR points in the current frame into the plurality of clusters equal to the number of objects counted in the previous frame.

20. The device of claim 11, wherein the instructions implemented to match the center points of the two or more objects in the previous frame with the center points of the plurality of clusters in the current frame are implemented to calculate a distance between each of the center points of the two or more objects in the previous frame and each of the center points of the plurality of clusters in the current frame and match points having shortest distances among the calculated distances.
